(19) United States
(12) Patent Application Publication
(10) Pub. No.: US 2011/0170276 A1
(43) Pub. Date: Jul. 14, 2011

(54) PHOTOGRAPHIC LIGHTING APPARATUS

(75) Inventors: Gary James Astill, Leicestershire (GB); Sean Justin Blair Henry, Warwickshire (GB)

(73) Assignee: LASTOLITE LIMITED, Leicestershire (GB)

(21) Appl. No.: 13/063,885

(22) PCT Filed: Sep. 15, 2009
(86) PCT No.: PCT/GB2009/051192

§ 371 Date: Mar. 14, 2011

(30) Foreign Application Priority Data
Sep. 16, 2008 (GB) 0816947.6

(51) Int. Cl. G03B 15/06

(52) U.S. Cl. 362/16

(57) ABSTRACT

A photographic lighting apparatus is adapted to rest upon a support surface, and comprises an operative panel having a light reflective and/or light transmissive wall, and a support member which supports the operative panel in an inclined orientation relative to the support surface. Such photographic lighting apparatus may be used as a light reflector or a light diffuser and is of particular utility for lighting the subject of a photograph from below.

### TECHNICAL FIELD

This invention relates to lighting apparatus for use in photography, and in particular to apparatus for reflecting and/or diffusing light.

### BACKGROUND

When illuminating the subject of a photograph, it is common to utilise apparatus for reflecting and/or diffusing light provided by a natural or artificial light source, such as a flash unit. In particular, a photographer may utilise one or more light reflectors and/or one or more light diffusers, which may be positioned to illuminate different surfaces of the subject. Light reflectors typically comprise a panel that has a reflective surface on at least one side, and is adapted to reflect incident light from a natural or artificial light source. The reflective surface may be adapted to at least partially determine the colour and/or other properties of the light falling on the subject. Light reflectors are commonly hand-held.

Light diffusers may also be hand-held, but often have the form of a light diffusion box, commonly known as a “softbox”. Light diffusion boxes typically comprise a generally pyramidal, tensioned fabric enclosure that is mounted on a lamp. The sides of the enclosure are usually opaque, while the base is translucent, typically being covered by a fabric sheet through which light from the lamp passes. The effect of the fabric sheet is to “soften” the light falling on the subject.

A disadvantage suffered by conventional apparatus for reflecting and/or diffusing light is that hand-held apparatus is typically difficult to arrange accurately and may require one or more assistants, whereas apparatus that includes a support structure is typically rather cumbersome and difficult to erect.

There has now been devised improved photographic lighting apparatus which overcomes or substantially mitigates the above-mentioned and/or other disadvantages associated with the prior art.

### SUMMARY

According to a first aspect of the invention, there is provided photographic lighting apparatus adapted to rest upon a support surface, the apparatus comprising an operative panel having a light reflective and/or light transmissive wall, wherein a support member is provided that is attachable to the operative panel, such that the light reflective and/or light transmissive wall is supported in an inclined orientation relative to the support surface and is adapted to direct light upwardly, in use.

The photographic lighting apparatus preferably comprises a base adapted to rest upon a support surface, wherein the support member is attachable to both the operative panel and the base, such that the light reflective and/or light transmissive wall is supported in an inclined orientation relative to the base and is adapted to direct light upwardly, in use.

The apparatus according to the invention is advantageous principally because it enables accurate lighting of the subject of the photograph from below and does not require the presence of an assistant or the erection of a cumbersome support structure. In addition, apparatus according to the invention enables accurate lighting of the subject of the photograph from below without any need for the apparatus to support the subject.

The photographic lighting apparatus is preferably adapted to be self-supporting, and hence be positionable upon a suitable surface, such as a floor, in a free-standing configuration during use. The base preferably has a substantially flat supporting surface, and is preferably of similar construction to the operative panel.

The support member is preferably attachable to both the operative panel and the base, at one end of the operative panel. The support member preferably supports the most elevated portion of the operative panel. The remainder of the operative panel may be unsupported. However, less elevated portions of the operative panel are preferably also attachable to the base. In particular, the least elevated portion of the operative panel is most preferably attachable to the base, and this attachment may be a permanent or removable attachment. In one embodiment, the least elevated portion of the operative panel is permanently attached to the base by a web of flexible material. In another embodiment, the least elevated portion of the operative panel is removably attached to the base by a fastener, for example strips of hook-and-loop fasteners on both the operative panel and the base.

In addition, the photographic lighting apparatus is preferably adapted to be collapsible. By “collapsible” is meant that the apparatus is reducible in size, most preferably by at least 75%, along at least one dimension. In presently preferred embodiments, the support member is removably attachable to the operative panel and/or the base, and most preferably removably attachable to both the operative panel and the base. However, the support member may instead be permanently attached, but also foldable, relative to the base and/or the operative panel.

The light reflective and/or light transmissive wall is preferably held under tension by a frame so as to form the operative panel of the apparatus. In particular, the frame is preferably resilient, and preferably comprises a fabric tube to which the light reflective and/or light transmissive wall is fixed and a resilient hoop accommodated within the fabric tube.

Where the support member is removably attachable to the operative panel and/or the base, the support member preferably includes one or more releasable fasteners, which are adapted to engage a peripheral portion of the operative panel and/or the base. The one or more releasable fasteners preferably have the form of a clamp, which is preferably resiliently biased into its engaged configuration. Where the operative panel and/or the base include a relatively rigid frame, the one or more releasable fasteners are preferably adapted to fasten to that frame. In particular, the one or more releasable fasteners may include a depression adapted to receive a portion of that frame, and the depression is preferably reducible in size in order to engage that portion of the frame. In addition, the one or more releasable fasteners may be adapted to be movable relative to the remainder of the support member. For instance, the one or more releasable fasteners may be mounted on support arms that are extendible and/or rotatable relative to the remainder of the support member.

The light reflective and/or light transmissive wall is preferably adapted to modify light from an external light source, such that the photographic lighting apparatus according to the invention is free of any light sources.

The support member is preferably adjustable in length to allow the angle at which the light reflective and/or light transmissive wall is supported to be altered. The adjustable support member is preferably telescopic in form, with a threaded fastener for securing the support member at the desired length.

The light reflective and/or light transmissive wall is preferably supported at an angle relative to the base of between 10° and 80°, and most preferably between 20° and 60°.

The light reflective and/or light transmissive wall preferably comprises a sheet of flexible material, and is most preferably held in tension in order to remove any creases or wrinkles. The light reflective and/or light transmissive wall may be formed of a woven or knitted fabric. However, in order to facilitate the removal of creases and wrinkles from the wall, the wall may be formed of an elastic material, such as a knitted fabric. Furthermore, the light reflective and/or light transmissive wall preferably has a smooth external surface, and therefore preferably includes a plastics coating on its external surface. The plastics coating is preferably smooth in form.

Where the operative panel includes a light transmissive wall, this wall preferably has a uniform partial transparency to visible light, and preferably acts to diffuse visible light that is transmitted therethrough. In addition, the light transmissive wall is preferably of white colouration.

Where the operative panel includes a light reflective wall, this wall preferably has an externally facing reflective surface. This reflective surface may be adapted to at least partially determine the colour and/or other properties of the light illuminating the photographic subject. The reflective surface may therefore be of white, silver or gold colouration.

In presently preferred embodiments, the operative panel and the base have a similar construction, as described above. In particular, the operative panel is preferably also adapted to rest upon a support surface, and the base preferably also has a light reflective and/or light transmissive wall, such that the base and the operative panel are interchangeable. In particular, the photographic lighting apparatus may be adapted to be repositioned, eg inverted, and/or assembled in a different configuration, such that the base functions as the operative panel, and the operative panel functions as the base.

The apparatus may be a light reflector and/or a light diffuser.

Hence, according to a further aspect of the invention, there is provided a light reflector adapted to rest upon a support surface, the apparatus comprising an operative panel having a light reflective wall, wherein a support member is provided that is attachable to the operative panel, such that the light reflective wall is supported in an inclined orientation relative to the support surface and is adapted to direct light upwardly, in use.

The light reflector preferably has the features described above in relation to the photographic lighting apparatus.

The operative panel preferably has a light reflective wall with a reflective surface on at least one side. The light reflector is preferably adapted to be assembled such that the reflective surface is an external surface of the light reflector, and is adapted to direct light upwardly, in use.

The base of the light reflector may also have a light reflective wall with a reflective surface on at least one side. The light reflector is preferably adapted to be assembled such that the reflective surface of the base is an external surface of the light reflector. In this configuration, the light reflector is preferably positionable on a support surface such that the base functions as the operative panel, and the operative panel functions as the base.

In addition, the operative panel and/or the base may have a light reflective wall with a reflective surface on both sides, such that the operative panel and the base are adapted to be assembled in any one of a plurality of configurations, in each of which one of the reflective surfaces of the operative panel and/or the base is an external surface of the light reflector, and is adapted to direct light upwardly, in use.

In presently preferred embodiments, the light reflector comprises two operative panels, each adapted to also function as the base of the light reflector, wherein the operative panels are adapted to be assembled in a plurality of configurations, in which different reflective surfaces of the operative panels are external surfaces of the light reflector, and are adapted to direct light upwardly, in use.

According to a further aspect of the invention, there is provided a light diffuser adapted to rest upon a support surface, the apparatus comprising an operative panel having a light transmissive wall, wherein a support member is provided that is attachable to the operative panel, such that the light transmissive wall is supported in an inclined orientation relative to the support surface and is adapted to direct light upwardly, in use.

The light diffuser preferably has the features described above in relation to the photographic lighting apparatus.

The light diffuser preferably includes an enclosure that is partially defined by the operative panel having a light transmissive wall. In this arrangement, the enclosure may also be partially defined by the base. Most preferably, the operative panel and the base of the light diffuser are connected by a web of flexible material, which together define the enclosure.

The light diffuser may also include a support for a light source, such that the light source is adapted to direct light into the enclosure. In particular, the support member that is attachable to the operative panel and the base may provide a support for the light source. In particular, the support member may include a mounting that is releasably attachable to a light source, such as a flash unit.

The enclosure preferably includes an additional light transmissive wall or an opening, through which light may be directed into the enclosure. The interior surface of the enclosure is preferably adapted to reflect at least a portion of the light directed into the interior of the enclosure by the light source, so that said light is reflected about the interior of the enclosure before being transmitted through the light transmissive wall. A major part of the interior surface of the enclosure is preferably adapted to reflect light incident thereon, and is preferably of white colouration.

### BRIEF DESCRIPTION OF THE DRAWINGS

Preferred embodiments of the invention will now be described in greater detail, by way of illustration only, with reference to the accompanying drawings, in which

FIG. 1 is a rear view of a light reflector according to the invention;

FIG. 2 is a side view of the light reflector of FIG. 1;

FIG. 3 is a front view of a panel that forms part of the light reflector of FIGS. 1 and 2;

FIG. 4 is a cross-sectional view along the line IV-IV in FIG. 3;

FIG. 5 is a first fragmentary side view of the light reflector of FIGS. 1 and 2 showing a close-up view of a retainer for engaging with a first panel of the apparatus;

FIG. 6 is a second fragmentary side view of the light reflector of FIGS. 1 and 2 showing a close-up view of a retainer for engaging with a second panel of the apparatus;

FIG. 7 is a rear view of a light diffuser according to the invention; and

FIG. 8 is a side view of the light diffuser of FIG. 7, upon which a flash unit has been mounted.

### DETAILED DESCRIPTION

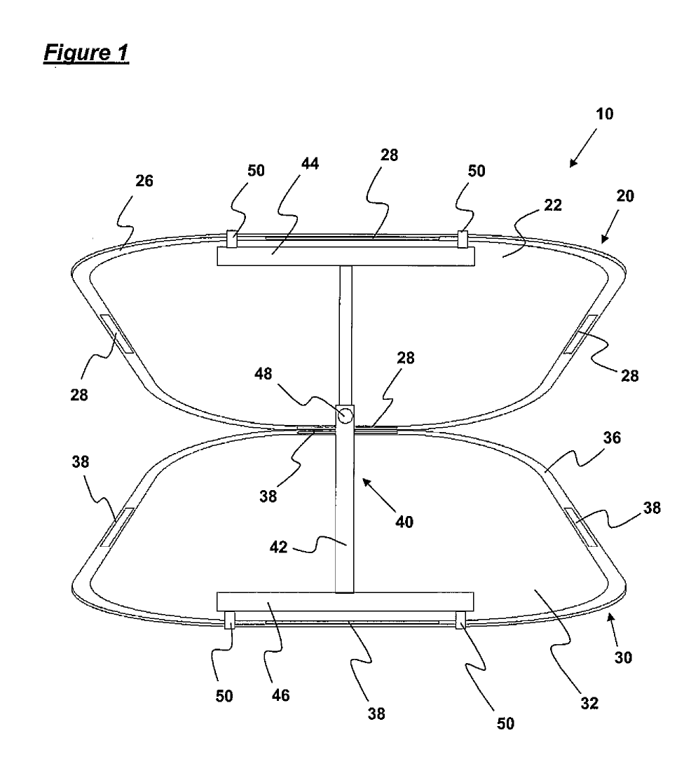

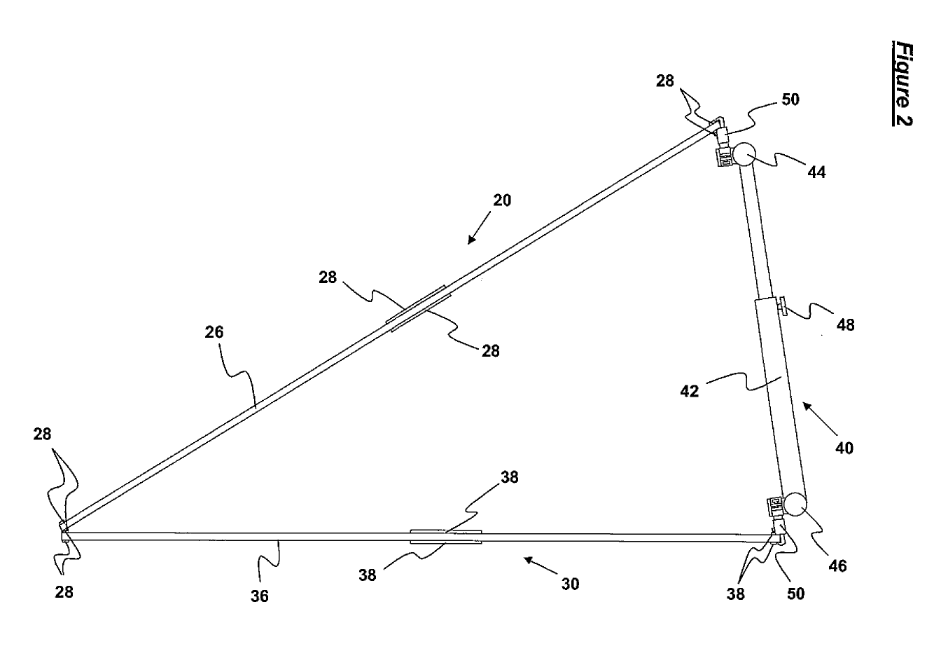

FIGS. 1 and 2 show a light reflector according to the invention, which is generally designated 10. The light reflector 10 comprises a first panel 20, a second panel 30, and an adjustable support 40. The first and second panels 20,30 are fastened together at one end of the panels 20,30, and are separated by the adjustable support 40 at the other end.

The first and second panels 20,30 each comprise a sheet of flexible material 22,32 mounted within a resilient frame 26,36. The sheets of flexible material 22,32 are formed of a fabric, with each of the four major surfaces of the two flexible sheets 22,32 defining a separate reflective surface. In particular, the four reflective surfaces each have different reflective properties. For instance, the light reflector 10 may include a matte white reflective surface, as well as three reflective surfaces having different shades of gold and silver. Where necessary, the flexible sheets 22,32 carry a coating, for example an elastomeric coating, to provide a reflective surface having the desired properties.

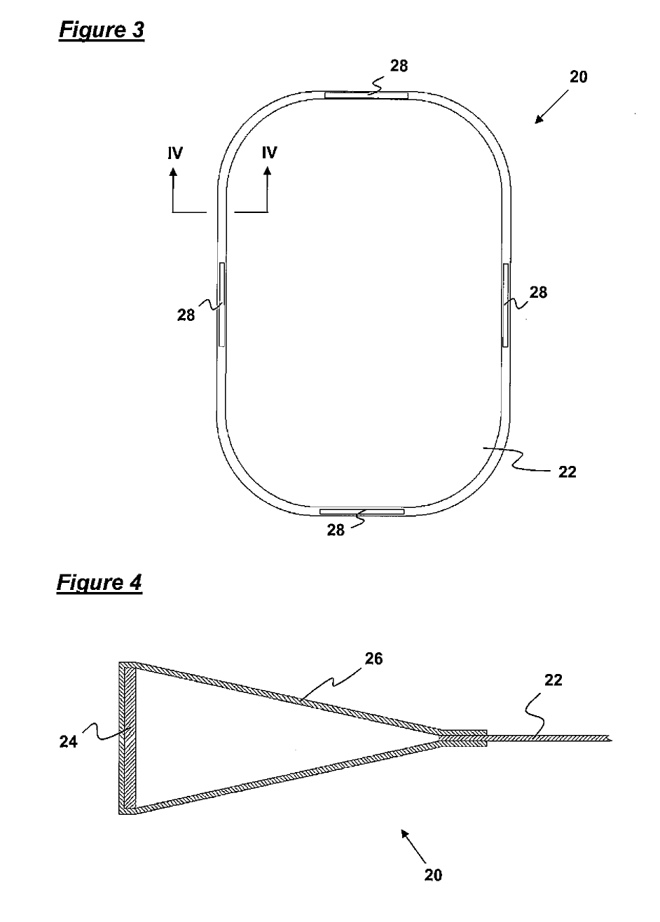

The first panel 20 of the light reflector 10 is shown in isolation in FIGS. 3 and 4. The first panel 20 comprises a fabric tube 26 stitched to the periphery of the flexible sheet 22, and a resilient hoop 24 within the fabric tube 26 that acts to maintain the sheet of flexible material 22 of the panel 20 in tension. The hoop 24 is typically formed from a band of carbon spring steel having a width of about 10 mm and the ends of which are clipped, welded or riveted together to form the hoop. The flexible sheet 22 is shaped so that the panel 20 is generally rectangular in shape, but with rounded corners, and the flexible sheet 22 is substantially free from wrinkles and creases. In particular, the first panel has two shorter sides of substantially equal length, and two relatively longer sides of substantially equal length. The second panel 30 has a similar structure to the first panel 20, save for the different properties of their reflective surfaces, as discussed above.

In addition, the first and second panels 20,30 include cooperating strips of hook-and-loop fastener 28,38, which are adapted to fasten the panels 20,30 together. In particular, each panel 20,30 has four strips of hook-and-loop fastener 28,38 arranged around each reflective surface. Each strip of hook-and-loop fastener 28,38 is mounted on the fabric tube 26 of the panel 20.

The strips of hook-and-loop fastener 28,38 are adapted so that the light reflector 10 may be assembled with any of the four reflective surfaces being inclined and facing upwardly, and hence adapted to illuminate a photographic subject. In addition, the panels 20,30 may be attached on either of the shorter sides, or either of the longer sides, in order to vary the height and width of the reflective surface, in use.

As shown most clearly in FIG. 1, the adjustable support 40 comprises a central strut 42, an upper cross-bar 44 at the upper end of the central strut 42, and a lower cross-bar 46 at the lower end of the central strut 42. The central strut 42 is telescopic in form, with a threaded fastener 48 that secures the central strut 42 with a desired length.

The upper cross-bar 44 includes a retainer 50 at each end, the retainers 50 extending upwardly and being adapted to engage the frame of the first panel 20. Similarly, the lower cross-bar 44 includes a retainer 50 at each end, the retainers 50 extending downwardly and being adapted to engage the frame of the second panel 30.

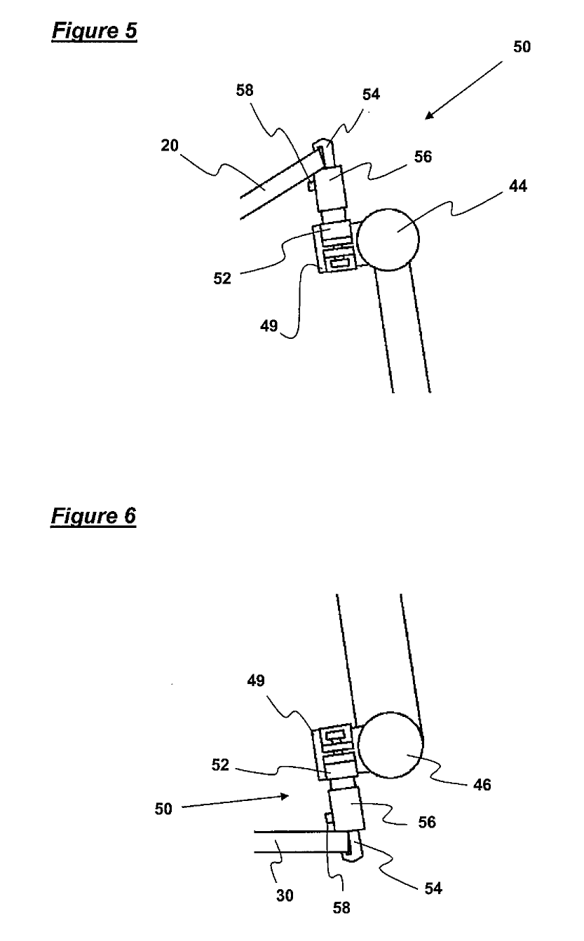

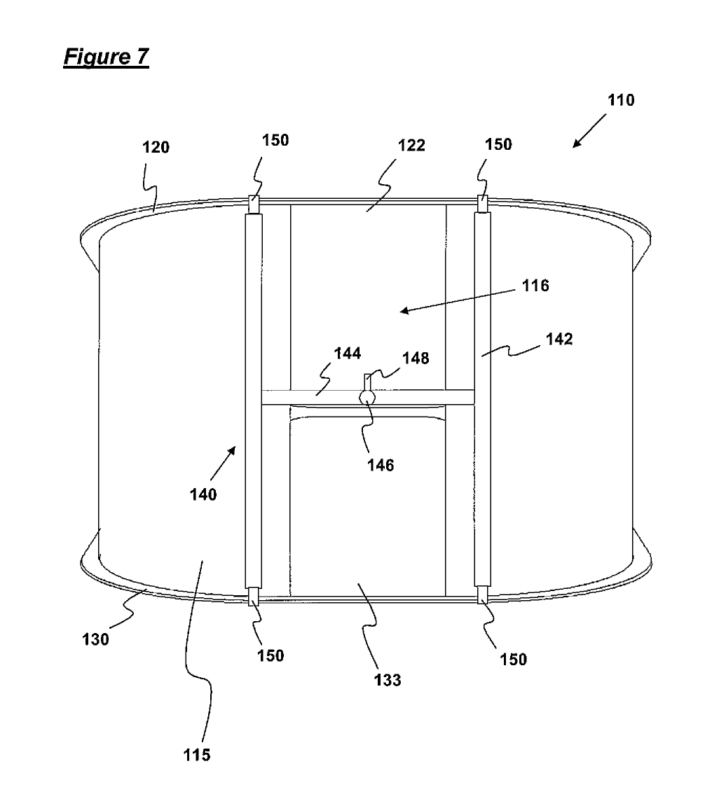

FIGS. 5 and 6 are close-up views of the retainers 50 of the first and second panels 20,30, respectively. Each retainer 50 comprises a collar 52 that is mounted on a generally cylindrical projection 49 of the associated cross-bar 44,46. Each collar 52 is has a variable radius, and is adapted to be rotatable about the cylindrical projection 49, until the collar 52 is reduced in size sufficiently for the collar 52 to frictionally engage the cylindrical projection 49 to maintain the retainer 50 in a desired position.

Each retainer 50 also includes a cylindrical housing 56, within which is mounted a spring-loaded retainer head 54 and an associated grip 58. The retainer-head 54 includes a depression adapted to receive the frame of either of the panels 20,30, and a projection adapted to be located alongside the interior surface of the resilient hoop 24. The retainer-head 54 is biased into the cylindrical housing 56, but is extendible using the associated grip 58, such that the frame of the associated panel 20,30 may be captivated between the retainer head 54 and a surface of the cylindrical housing 56.

As discussed above, the light reflector 10 may be assembled with any of the four reflective surfaces of the two panels 20,30 being inclined and facing upwardly. In addition, the panels 20,30 may be attached on either of the shorter sides, or either of the larger sides, in order to vary the height and width of the reflective surface.

In use, the light reflector 10 is therefore assembled with the desired reflective surface being inclined and facing upwardly, and with a desired height and width. The light reflector 10 is then placed upon a suitable surface, typically the floor, such that the upper surface of the upper panel 20,30 is adapted to reflect light towards a photographic subject, from below. The light reflected by the light reflector 10 may be provided by an artificial light source, such as a flash unit, by sunlight, or by a combination of natural and artificial light.

With the adjustable support 40 engaged with the first and second panels 20,30, as shown in FIGS. 1 and 2, the light reflector 10 retains its shape during use. When the light reflector 10 is no longer needed, it can be collapsed by removing the adjustable support 40. In particular, the adjustable support 40 is removed by disengaging the retainers 50 from the first and second panels 20,30. Once the adjustable support 40 has been disengaged from the panels 20,30, the panels 20,30 may be laid alongside one another. If desired, the light reflector 10 may then be collapsed further by grasping opposite sides of the folded panels 20,30 and twisting the folded panels 20,30 to form loops which can then be folded over. The panels 20,30 are adapted to maintain this folded configuration either without assistance, or when placed in an appropriately sized bag.

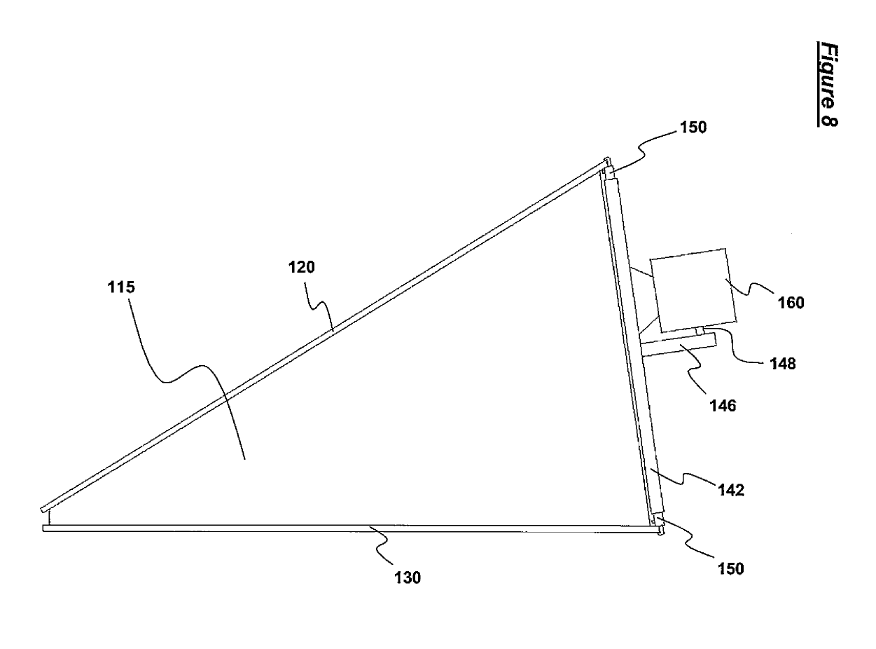

FIG. 7 shows a light diffuser according to the invention, which is generally designated 110. The light diffuser 110 comprises upper and lower panels 120,130, which have essentially the same structure as the panels 20,30 of the light reflector 10 described above, save for the absence of any strips of hook-and-loop fastener and also the different light modifying properties of the panels 120,130, as described in more detail below. The light diffuser 110 also comprises a connecting web 115 and a support member 140. The connecting web 115 and the panels 120,130 together define an enclosure of the light diffuser 110.

The connecting web 115 is generally tubular in form, and extends between the frames of the panels 120,130, thereby defining the enclosure of the light diffuser 110. In particular, the upper and lower edges of the connecting web 115 are stitched to the fabric tubes of the panels 120,130. A full-height, rectangular opening 116 is formed in the connecting web 115 at one end of the light diffuser 110, and the connecting web 115 has a gradually decreasing height towards the other end of the light diffuser 110. Indeed, at the end of the light diffuser 110 in which the opening 116 is formed in the connecting web 115, the panels 120,130 are separated by the support member 140, but at the other end the panels 120,130 simply rest upon one another.

Each panel 120,130 of the light diffuser 110 comprises a flexible sheet 122,132 that is formed of a translucent fabric having the desired light-modifying properties. In particular, each flexible sheet 122,132 is adapted to diffuse light transmitted therethrough. In contrast, the connecting web 115 is formed of an opaque fabric, with a matte white internal surface.

The support member 140 comprises two struts 142 that each extend between the frames of the upper and lower panels 120,130. In particular, each strut 142 has a retainer 150 extending axially from each of its ends, each retainer 150 consisting of the cylindrical housing, spring-loaded retainer head 54 and associated grip 58, as described above in relation to the light reflector 10.

The support member 140 also includes a cross-bar 144 that extends between the mid-portions of the two struts 142, the cross-bar 144 being orientated perpendicularly to the two struts 140 and parallel to the lower panel 130. A light source support arm 146 extends from a mid-portion of the cross-bar 144, and includes a mounting 148 for the light source 160 (shown in FIG. 8). The light source support arm 146 is orientated parallel to both the two struts 142 and the cross-bar 144, and extends away from the opening 116 into the enclosure of the light diffuser 110.

In use, the support member 140 is arranged with the two struts 142 either side of the opening 116, and a light source 160 is mounted on the mounting 148, such that the light source 160 directs light, in use, into the enclosure of the light diffuser 110. In addition, the light diffuser 110 is placed upon a suitable surface, typically the floor, such that the upper surface of the upper panel 120 is adapted to transmit diffused light towards a photographic subject, from below.

With the support member 140 engaged with the first and second panels 120,130, as shown in FIGS. 7 and 8, the light diffuser 110 retains its shape during use. When the light diffuser 110 is no longer needed, it can be collapsed by removing the support member 140. In particular, the support member 140 is removed by disengaging the retainers 150 from the upper and lower panels 120,130. Once the support member 140 has been disengaged from the panels 120,130, the panels 120,130 may be laid alongside one another, with the connecting web 115 folded between the panels 120,130. If desired, the light diffuser 110 may then be collapsed further by grasping opposite sides of the folded panels 120,130 and twisting the folded panels 120,130 to form loops which can then be folded over. The panels 120,130 are adapted to maintain this folded configuration either without assistance, or when placed in an appropriately sized bag.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A photographic lighting apparatus adapted to rest upon a support surface, the apparatus comprising:
an operative panel having a wall that is one or both of a light reflective and light transmissive, wherein a support member is provided that is attachable to the operative panel, such that the wall is supported in an inclined orientation relative to the support surface and is adapted to direct light upwardly in use.

2. The apparatus of claim 1, further comprising a base adapted to rest upon a support surface.

3. The apparatus of claim 2, wherein the base has a substantially flat supporting surface.

4. The apparatus of claim 2, wherein the base and operative panel are of similar construction such that the base and the operative panel are interchangeable.

5. The apparatus of claim 4, wherein the operative panel is also adapted to rest upon a support surface, and the base also has a wall that is one of both of light reflective and light transmissive, such that the base and the operative panel are interchangeable.

6. The apparatus of claim 2, wherein the support member is attachable to both the operative panel and the base and supports a most elevated portion of the operative panel.

7. The apparatus of claim 2, wherein a least elevated portion of the operative panel is attached to the base.

8. The apparatus of claim 1, wherein the apparatus is adapted to be collapsible.

9. The apparatus of claim 1, wherein the operative panel includes a relatively rigid frame comprising a fabric tube to which the wall is fixed and a resilient hoop accommodated within the fabric tube.

10. The apparatus of claim 1, wherein the support member is removably attachable to the operative panel by one or more releasable fasteners, which are adapted to engage a peripheral portion of the operative panel.

11. The apparatus of claim 10, wherein the one or more releasable fasteners have the form of clamps which are resiliently biased into the engaged conformation.

12. The apparatus of claim 10 wherein, where the operative panel includes a relatively rigid frame, the one or more releasable fasteners are adapted to fasten to that frame.

13. The apparatus of claim 12, wherein the releasable fasteners include a depression adapted to receive a portion of the frame and which may be reduced in size in order to engage that portion of the frame.

14. The apparatus of claim 10, wherein the one or more releasable fasteners are mounted on support arms that are one or both of extendible and rotatable relative to the remainder of the support member.

15. The apparatus of claim 1, wherein the support member is adjustable in length.

16. The apparatus of claim 2, wherein the wall is supported at an angle relative to the base of between 10° and 80° or between 20° and 60°.

17. The apparatus of claim 1, wherein the wall is adapted to modify light from an external light source.

18. The apparatus of claim 1, wherein the wall comprises a sheet of flexible material.

19. The apparatus of claim 1, wherein the operative panel includes a light reflective wall.

20. The apparatus of claim 19, wherein the operative panel has an externally facing reflective surface adapted to at least partially determine one or more properties of light illuminating a photographic subject.

21. The apparatus of claim 19 wherein the apparatus includes a base adapted to rest upon a support surface, the external surface of which has a light reflective surface, such that the base and the operative panel are interchangeable.

22. The apparatus of claim 19, wherein the operative panel has a light reflective wall with two sides, and a reflective surface on both of the two sides.

23. The apparatus of claim 19, wherein the apparatus comprises two operative panels, each of which are also adapted to function as a base.

24. The apparatus of claim 1, wherein the operative panel includes a light transmissive wall.

25. The apparatus of claim 24, wherein the light transmissive wall has a uniform partial transparency to visible light.

26. The apparatus of claim 21, wherein the apparatus includes an enclosure that is partially defined by the operative panel.

27. The apparatus of claim 26 wherein the apparatus includes a base adapted to rest upon a support surface, the operative panel and the base being connected by a web of flexible material, and the operative panel, base and web together defining the enclosure.

28. The apparatus of claim 26, wherein the enclosure includes an additional light transmissive wall or an opening, through which light may be directed into the enclosure.

29. The apparatus of claim 26, wherein the enclosure has an interior surface, at least a part of which is adapted to reflect light incident thereon.

30. The apparatus of claim 24, wherein the apparatus further comprises a support for a light source.

31.-32. (canceled)
